(19) United States
(12) Patent Application Publication
(10) Pub. No.: US 2026/0357624 A1
(43) Pub. Date: Nov. 12, 2026

(54) MOTOR VEHICLE LOCK LOCKING MECHANISM

(71) Applicant: Kiekert Aktiengesellschaft, Heiligenhaus (DE)

(72) Inventors: Michael SCHOLZ, Essen (DE); Holger SCHIFFER, Meerbusch (DE); Peter SZEGENY, Engelskirchen (DE); Ömer INAN, Dorsten (DE)

(73) Assignee: Kiekert Aktiengesellschaft, Heiligenhaus (DE)

(21) Appl. No.: 19/125,805

(22) PCT Filed: Oct. 16, 2023
(86) PCT No.: PCT/DE2023/100770

§ 371 Date: May 7, 2025

(30) Foreign Application Priority Data
Nov. 2, 2022 (DE) 10 2022 128 903.6

(51) Int. Cl. E05B 85/26; E05B 85/24

(52) U.S. Cl. CPC E05B 85/26; E05B 85/245

(57) ABSTRACT

The invention relates to a motor vehicle lock locking mechanism, in particular a motor vehicle door lock locking mechanism, equipped with at least one rotary latch (1, 2) as well as a preliminary catch pawl (3) and a main catch pawl (4) as at least two catch pawls (3, 4). The two catch pawls (3, 4) are mounted so as to be coaxial with each other. Additionally, the preliminary catch pawl (3) interacts with a preliminary catch (1a) of the rotary latch (1, 2) on a preliminary catch plane whereas the main catch pawl (4) interacts with a main catch (2a) of the rotary latch (1, 2) on a main catch plane arranged parallel and at a distance to the preliminary catch plane. According to the invention, the rotary latch (1, 2) is composed of a main catch rotary latch (2), which has the main catch (2a), and a preliminary catch rotary latch (1), which has the preliminary catch (1a), said latches being connected together in a sandwiched manner.

The invention relates to a motor vehicle locking mechanism, in particular a motor vehicle door lock locking mechanism, with at least one rotary latch as well as a preliminary catch pawl and a main catch pawl as as at least two catch pawls, wherein the two catch pawls are mounted so as to be coaxial with one another and rotatably, and the preliminary catch pawl interacts with a preliminary catch of the rotary latch in a preliminary catch plane, and the main catch pawl interacts with a main catch of the rotary latch in a main catch plane parallel thereto and at a distance from the preliminary catch plane.

Locking mechanisms of motor vehicle locks, i.e. motor vehicle lock locking mechanisms, mainly perform a securing function and ensure overall that not only a motor vehicle door equipped with the motor vehicle lock and consequently also the motor vehicle lock locking mechanism can be securely locked relative to a motor vehicle body. Structural forces are transmitted via the motor vehicle lock locking mechanism in particularly also in the event of a crash. At the same time, it is important to keep any operating forces for opening the lock as low as possible and moreover to keep noises associated with lock opening to a minimum.

In order to be able to implement the above-described and per se conflicting requirements as a whole, there are already various approaches in the prior art. In DE 10 2010011 322 A1 , for example, a convex curvature is used that is located in an area of the rotary latch, at least in a section extending in contact with the striker or a locking bolt. For this purpose, the rotary latch as a whole can be equipped with a sandwich-like structure. As a result of the convex curvature, there is a rounded contact area on the striker or locking bolt and an overall reduction in unwanted noise emissions, which could previously be attributed to a relative movement between the striker or locking bolt and the rotary latch.

Also for reasons of noise emission and in accordance with the teaching according to WO 2020/083435 A1 , a latching element is often pivotably mounted on the rotary latch and/or the pawl for the most part in a locking plane. As a result, in the engagement area between the two locking components, there is ultimately no grinding movement against each other, for example during an opening process, but the pivotably mounted latching element ensures a predominantly rolling relative movement to each other.

The generic prior art according to WO 2008/061491 A1 proceeds in such a way that a first catch pawl or main catch pawl is realized, and additionally a second catch pawl or preliminary catch pawl. The first catch pawl or main catch pawl can be brought into engagement with a main catch on the rotary latch. In contrast, the second catch pawl or preliminary catch pawl can be brought into engagement with a preliminary catch on the rotary latch. In the example, the preliminary catch on the rotary latch is a bolt-like pin on the rotary latch.

In this way, a self-opening mechanism is provided overall. In fact, the design of the generic teaching according to WO 2008/061491 A1 is such that, in the locked state, the rotary latch introduces a pivoting moment into the first catch pawl or main catch pawl. In so doing, the first catch pawl is fixed with the aid of a blocking lever. As soon as the blocking lever releases the catch pawl to open the locking mechanism, the rotary latch swivels the first catch pawl or main catch pawl in the direction of the open position. This means that the associated operating forces when opening are relatively low.

The prior art has basically proven itself, but is still in need of improvement with regard to the safety requirements that still must be taken into account in addition to the low opening forces and the minimization of any noise emissions. High demands are placed on this type of vehicle lock locking mechanism with regard to the tearing forces that can be absorbed, which can be up to half a ton and more both in the preliminary catching position and in the main catching position. Since in the generic prior art according to WO 2008/061491 A1 the preliminary catching is only defined by a bolt-like pin on the rotary latch, which extends into the preliminary catch plane, it cannot be ensured that such tearing forces can also be absorbed perfectly in the preliminary catching position. The invention aims to provide an overall remedy in this regard.

The invention is based on the technical problem of further developing such a motor vehicle lock locking mechanism and in particular a motor vehicle door lock locking mechanism in such a way that all security requirements are met better than before, and at the same time an embodiment with low opening forces and reduced noise emissions is observed.

To solve this technical problem, the invention proposes, on the basis of a generic motor vehicle lock locking mechanism, that the rotary latch is composed of a main catch rotary latch having the main catch and a preliminary catch rotary latch having the preliminary catch which are connected to one another in a sandwich-like manner.

According to the invention, therefore, in addition to the main catch rotary latch having the main catch as in the generic prior art according to WO 2008/061491 A1 , a preliminary catch rotary latch having the preliminary catch is also provided which, in contrast to the prior art, is not limited to a bolt-like pin. Rather, according to the invention, the preliminary catch rotary latch having the preliminary catch has its own surface extension which corresponds predominantly to that of the main catch rotary latch. In this way, the main catch rotary latch and the preliminary catch rotary latch can be stacked together like a sandwich.

Such a sandwich-like stacked connection is already propagated in the prior art according to DE 10 2010 011 322 A1 for a rotary latch, but there against the background of realizing and implementing the convex curvature desired at this point, in particular in the striker receiver of the rotary latch, by means of the inserted layer. In contrast, the process according to the invention is such that the main catch rotary latch and the preliminary catch rotary latch are each plate-shaped with a predominantly matching surface. The predominant matching surface is observed in particular in the area of an striker receiver and/or a bearing opening of the rotary latch.

This means that the main catch rotary latch and the preliminary catch rotary latch are each designed plate-shaped or disk-shaped. The two plates or disks are connected to each other stacked like a sandwich. At this point, there is predominant surface matching between the main catch rotary latch and the preliminary catch rotary latch, in particular in the area of the striker receiver into which a locking bolt or striker typically enters during a closing process and is caught therein. The striker receiver is generally bounded by two arms, namely a stop arm and a load arm of the rotary latch.

During a closing process of a motor vehicle door equipped with the motor vehicle lock locking mechanism according to the invention, the locking bolt moves into the striker receiver and, with its contact or stop on the stop arm of the rotary latch, ensures that the rotary latch transitions into its closed position. In so doing, the rotary latch first assumes its preliminary catching position and then the main catching position. The load arm, on the other hand, mainly absorbs the applied tearing forces.

According to a further advantageous embodiment, both the main catch rotary latch and the preliminary catch rotary latch are designed as stamped metal parts, for example. The relevant stamped metal parts can be made from the same or different metals.

In an advantageous embodiment of the invention, the main catch rotary latch and the preliminary catch rotary latch are made of materials of different hardness and/or are coated in materials of different hardness. For example, it is conceivable that the main catch rotary latch is made of a harder material than the preliminary catch rotary latch or is coated with a harder material. This increases the overall strength of the rotary latch without it having or needing to have a particularly high material thickness or for additional reinforcement measures having to be integrated. It is also advantageous if the coating and/or the material of the preliminary catch rotary latch protrudes slightly from the coating and/or the material of the main catch rotary latch. It can be provided that the coating and/or the material of the preliminary catch rotary latch protrudes a few tenths of a millimeter beyond the coating and/or the material of the main catch rotary latch. This has the advantage that contact with the catch pawl, for example, only occurs on the softer material, which further improves the acoustics. In this way, the noise behavior is positively influenced with the simultaneous fulfillment of the safety requirements. This can be attributed to the fact that, within the context of a particularly advantageous embodiment, the main catch rotary latch is equipped with a latching element pivotably mounted thereon. As a result, any opening and closing processes starting from the main catch are carried out particularly quietly and with low operating forces. The latching element can be at least partially secured and covered using the preliminary catch rotary latch. In this context, additional guides ensure that there is no preliminary catch engagement or that the main catch pawl can engage in a necessary free space between the latching element and a seat bearing the latching element. The relevant guides can be realized on the main catch rotary latch and/or the main catch pawl.

Either way, low operating forces and noise emissions are observed in the main catch and the necessary strengths are simultaneously observed. The same applies to the preliminary catch. Since in the described example the preliminary catch rotary latch can be made of a softer material in comparison to the main catch rotary latch or can be coated with such, this also positively influences the closing behavior and corresponding noise emissions. According to the invention, this is also possible without a latching element being present or having to be present on the preliminary catch rotary latch, which is also conceivable at this point and pivotably mounted thereon.

The main catch rotary latch and the preliminary catch rotary latch can be connected to each other in various ways stacked like sandwich. For example, it is conceivable to use typical mechanical connections such as coupling by rivets, screws, stamping, etc. at this point. Of course, the mentioned measures can also be combined with each other. In general, the procedure is such that the main catch and the preliminary catch are connected to each other at least at points.

The preliminary catch pawl and the main catch pawl are rotationally coupled to each other in such a way that the preliminary catch pawl entrains the main catch pawl after a defined idle travel, for example when the locking mechanism is opened. This ensures that the rotary latch is completely released from both the preliminary catch pawl and the main catch pawl during an opening process and can swing open so that the locking bolt or striker caught in the striker receiver between the stop arm and load arm is released. The associated motor vehicle door can be opened without any problems.

As a result, a motor vehicle lock locking mechanism and, in particular, a motor vehicle door lock locking mechanism is provided and supplied which both fulfills all security-specific requirements and can be opened with low actuating forces. In addition, particularly quiet operation is observed. That is, the conflicting requirements described above have been depicted and reflected together for the first time in the context of the present invention. Ultimately, this can be attributed to the combination of the stacked sandwich-like structure of the rotary latch consisting of the main catch rotary latch and the preliminary catch rotary latch on the one hand in conjunction with the additional latching element on the main catch rotary latch on the other. Due to the sandwich-like stack between the main catch rotary latch and the preliminary catch rotary latch and their mechanical connection to each other, practically any strengths can be realized and implemented for the rotary latch without the need for additional and supplementary complex reinforcement measures.

Furthermore, as a result of the advantageous and additionally realized latching element, the opening process of the locking mechanism in particular is achieved with little force because the latching element allows and defines a rolling movement between the locking mechanism parts moving relative to each other, whereas in the previous state of the art, mainly grinding movements are observed at this point.

All of this is possible taking into account an economical and structurally simple design because both the main catch rotary latch as well as the preliminary catch rotary latch, as well as the main catch pawl and the preliminary catch pawl, are typically stamped metal parts that can be manufactured economically and with the desired properties without any problems. The connection between the main catch rotary latch and the preliminary catch rotary latch only requires an established mechanical connection process such as the insertion of rivets, screws, stamping or, in principle, welding the two rotary latches together. A point connection at three points, for example, is sufficient so that this further reduces the manufacturing effort.

These are considered to be the main advantages.

In the following, the invention is explained in more detail with reference to a drawing showing only one embodiment in which:

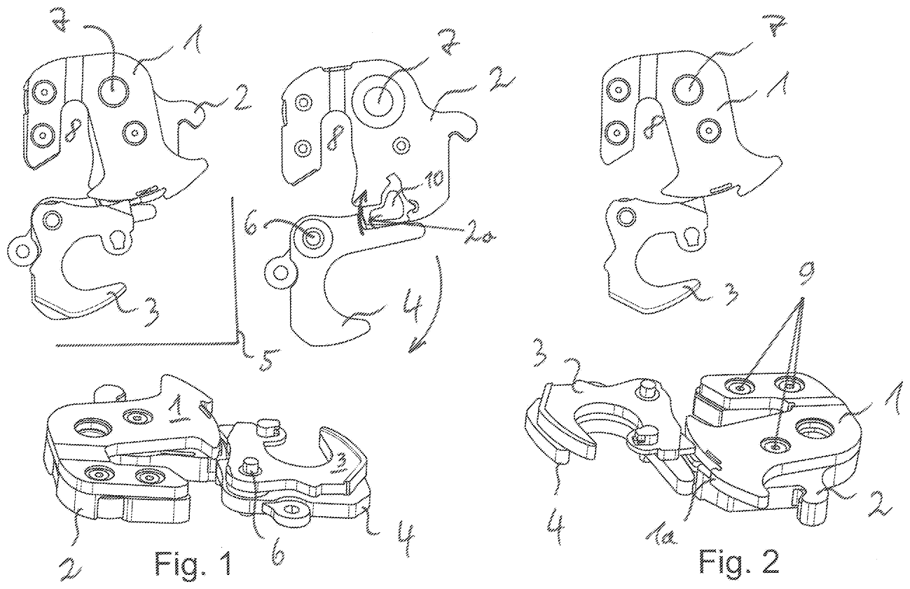

FIG. 1 shows the motor vehicle lock locking mechanism according to the invention in the form of a motor vehicle door lock locking mechanism in plan view and partially in perspective in the main latching position, and

FIG. 2 schematically shows the motor vehicle lock locking mechanism according to FIG. 1 in the preliminary catching position,

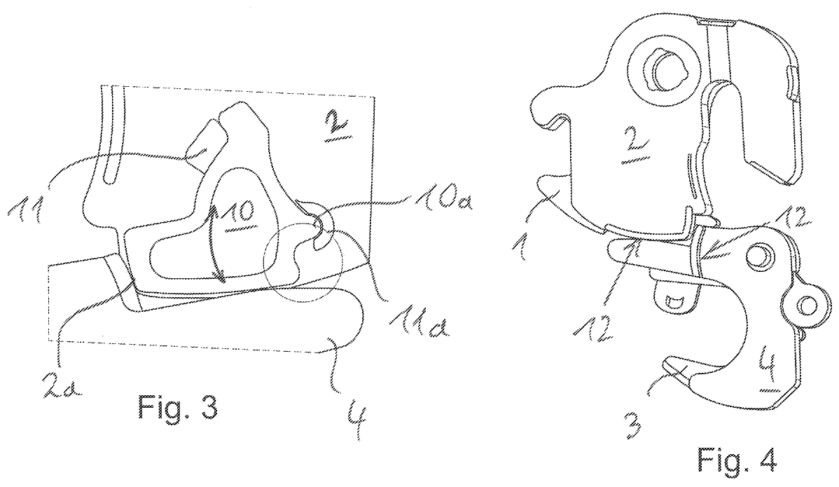

FIG. 3 shows a detail from FIGS. 1 and 2, and

FIG. 4 a shows a further detail in the area of the provided latching element.

The figures illustrate a motor vehicle lock locking mechanism and, in particular, a motor vehicle door lock locking mechanism. This consists of at least one rotary latch 1, 2 as well as a preliminary catch pawl 3 and a main catch pawl 4 as at least two catch pawls 3, 4. The rotary latch 1, 2 in conjunction with the two catch pawls 3, 4 can generally be rotatably mounted in a metal lock case 5 indicated in FIG. 1 and represents the essential component of a motor vehicle lock and, in particular, a motor vehicle door lock, which is not otherwise shown. The term motor vehicle lock or motor vehicle door lock is to be interpreted very generally and broadly in accordance with the invention and ultimately comprises any locking devices with the aid of which flaps, hoods, doors etc. in or on a motor vehicle are locked.

A comparison of FIGS. 1 and 2 shows that the two catch pawls 3, 4 are mounted coaxial with each other. For this purpose, both catch pawls 3, 4 have aligned bores for the engagement of a bearing bolt 6. The bearing bolt 6, as well as another bearing bolt 7 not shown in detail, is anchored in a bearing opening for the rotary latch 1, 2 in the lock case 5.

According to the embodiment example and not restrictively, both catch pawls 3, 4 are each C-shaped in plan view, wherein the bearing pin 6 is arranged in the area of the connection of both C-legs. One C-leg of the relevant catch pawl 3, 4 may typically be used to pivot the pawl 3, 4. In contrast, the other C-leg interacts with the rotary latch 1, 2, as will be explained in more detail below.

It should be emphasized that the C-shape of the two catch pawls 3, 4 described above as an example is primarily because or due to the fact that the relevant catch pawls 3, 4 are equipped with a predominantly invisible metallic core and a plastic coating. That is, the plastic coating provides the described C-shape. The metallic core can be designed differently. The realized C-shape of the plastic coating makes it particularly elegant and advantageous to apply pressure to individual sensors or switches not shown. With the aid of these sensors or switches, the movement of the catch pawls 3, 4 can be interrogated, and the functional state of the locking mechanism can be thereby inferred. For this purpose, the C-arm remote from the rotary latch may interact with the sensors or switches.

In fact, the overall design is such that the preliminary catch pawl 3 is such that it interacts with a preliminary catch 1a of the rotary latch 1, 2 in a preliminary catch plane spanned by the preliminary catch pawl 3. In contrast, the main catch pawl 4 interacts with a main catch rotary latch 2a of the rotary latch 1, 2 in a main catch plane parallel to and at a distance from the aforementioned preliminary catch plane. This main catch plane is therefore primarily spanned and described by the main catch pawl 4. According to the embodiment, the main catch rotary latch 2a is formed on a latching element 10 (see FIGS. 1 and 3).

According to the invention, the rotary latch 1, 2 now consists of a main catch rotary latch 2 having the main catch 2a on the one hand and additionally a preliminary catch rotary latch 1 having the preliminary catch 1a on the other hand. Both rotary latches 1, 2 are connected to each other stacked like a sandwich as can be seen in particular from the perspective views in FIGS. 1 and 2.

The overall design is such that, according to the embodiment, both the main catch rotary latch 2 as well as the preliminary catch rotary latch 1 are each designed plate-shaped or disk-shaped with a predominantly matching surface. In the context of the embodiment, this predominant matching surface is observed in particular in the area of a striker receiver 8 of the rotary latch 1, 2 and moreover in the area of the bearing opening 7 which is provided to receive the bearing bolt rotatably supporting the rotary latch 1, 2.

According to the embodiment, both the main catch rotary latch 2 as well as the preliminary catch rotary latch 1 are stamped metal parts. These can be made of the same or different metals. It is also conceivable that the main catch rotary latch 2 as well as the preliminary catch rotary latch 1 have a coating not shown in the embodiment. Of course, the relevant coating is just as easily dispensable. In one embodiment of the invention, the main catch rotary latch 2 and the preliminary catch rotary latch 1 are made of materials of different hardness and/or are coated with in materials of different hardnesses. For example, it is conceivable that the main catch rotary latch 2 is made of a harder material than the preliminary catch rotary latch 1 or is coated with a harder material. This increases the overall strength of the rotary latch without it having or needing to have a particularly high material thickness or for additional reinforcement measures having to be integrated. It is also advantageous if the coating and/or the material of the preliminary catch rotary latch 1 protrudes slightly from the coating and/or the material of the main catch rotary latch 2. In a further embodiment, it can be provided that the coating and/or the material of the preliminary catch rotary latch 2 protrudes a few tenths of a millimeter beyond the coating and/or the material of the main catch rotary latch 1. This has the advantage that contact with the catch pawl 3, 4, for example, only occurs on the softer material, which further improves the acoustics. In this way, the noise behavior is positively influenced with the simultaneous fulfillment of the safety requirements.

It can be seen that the main catch rotary latch 2 and the preliminary catch rotary latch 1, in the context of the embodiment, are connected to each other stacked like a sandwich in the embodiment, at least at points. According to the embodiment, a total of three connection points 9 are realized between the preliminary catch rotary latch 1 and the main catch rotary latch 2. According to the embodiment, the connection points 9 are each realized and implemented by riveted connections. In principle, screw connections, stamps or even welds can also be used here in order to couple the two rotary latches 1, 2 to each other fixed against rotation. The connection points 9 form a triangle for this purpose. A load arm of the rotary latch 1, 2 is equipped with two connection points 9 in order to thereby provide the required strength (keyword: tearing forces).

According to the embodiment, the two catch pawls 3, 4 are also each designed plate-shaped or disk-shaped. As in the case of the two rotary latches 1, 2, these can also be stamped metal parts. It is conceivable to employ the same or different metals. In contrast to the two rotary latches 1, 2, the catch pawls 3, 4 are contrastingly not coupled to each other in a rotationally fixed manner.

Rather, the preliminary catch pawl 3 and the main catch pawl 4 are rotationally coupled to each other in such a way that the preliminary catch pawl 3 entrains the main catch pawl 4 during an opening process and after a defined idle travel. This idle travel is typically required if the main catch rotary latch 2 opens faster than the preliminary catch rotary latch 1. Either way, the relevant idle travel between the two catch pawls 3 and 4 prevents any preliminary catch engagement.

In a comparison of FIGS. 1, 2 and 3, 4, it is clear that the main catch rotary latch 2 is equipped with the latching element 10 pivotably mounted thereon. This can be seen in particular from the enlarged illustration in FIG. 4. In this case, the latching element 10 is held in a seat 11 in the main catch rotary latch 2. In fact, the latching element 10 ensures overall that during an opening process of the locking mechanism, there is an overall rolling process between the main catch pawl 4 on the one hand and the main catch rotary latch 2 on the other. This results in a particularly low-force opening process which is also associated with reduced noise emissions.

Since the latching element 10 is mounted in the seat 11 taking into account a free space circled in FIG. 4, which ultimately permits the mentioned pivoting movements of the latching element 10 relative to the main catch rotary latch 2, for example during the opening process, additional guides 12 are provided in order to prevent any engagement of the main catch rotary latch 4 in the relevant free space. The relevant guides 12 are located on the one hand on the main catch pawl 4 and on the other hand on the main catch rotary latch 2, as shown in the illustration in FIG. 3 and limited to the embodiment. This is of course only an example and is in no way restrictive.

In any case, the guides 12 as a whole ensure that the main catch pawl 4 can only engage during a locking operation of the locking mechanism when the rotary latch 1, 2 or the main catch rotary latch 2 with the latching element 10 mounted therein has safely passed the projection on the main catch pawl 4 interacting with the main catch 2a on the main catch rotary latch 2.

FIG. 4 finally reveals that the latching element 10 as a whole is equipped with a lug 10a which engages in an curved area 11a of the seat 11. In this way, the lug 10a on the one hand and the curved area 11a of the seat 11 on the other hand together define a swivel joint 10a, 11a, which permits rotational movements of the catch element 10 about the axis defined thereby, as indicated by a double arrow in FIG. 4. This results in the rolling movement already described when the locking mechanism is opened.

This is because this opening movement corresponds to the preliminary catch pawl 3 and subsequently the main catch pawl 4 being pivoted about their common axis, defined by the bearing bolt 6, in the clockwise direction indicated in FIG. 1 so that as a result, the latching element 10 can roll counterclockwise on the edge about its pivot point defined by the joint 10a, 11a until the two catch pawls 3, 4 ultimately release the rotary latch 1, 2 which in turn then swings open clockwise about the axis of rotation defined by the receiving opening 7 and releases a locking bolt previously trapped in the striker receiver 8 and not shown. As a result thereof, an associated motor vehicle door, flap or the like can be opened.

To ensure that the latching element 10 does not axially leave the plane defined by the seat 11 during the described opening process and in general with regard to its pivoting movements while forming the joint 10a, 11a, the preliminary catch rotary latch 1 is configured to at least partially secure and cover the latching element 10. That is, in the embodiment, it can be seen that the latching element 10 is ultimately arranged between the seat 11 in the main catch rotary latch 2 on the one hand and the preliminary catch rotary latch 1 at least largely covering the receptacle 11, on the other hand. As a result, the latching element 10 is sandwiched, as it were, between the seat 11 or a base of the seat 11 on the one hand and the overlap on the part of the preliminary catch rotary latch 1 on the other hand and is secured against any axial movements.

### LIST OF REFERENCE SIGNS

1 Preliminary catch rotary latch
1a Preliminary catch
1,2 Rotary latch
2 Main catch rotary latch
2a Main catch
3 Preliminary catch pawl
3,4 Catch pawl
4 Main catch pawl
5 Lock case
6 Bearing bolt
7 Bearing opening
8 Striker receiver
9 Connecting points
10 Latching element
10a Lug
10a, 11a Swivel joint
11 Seat
11a Curved area
12 Guides

1. A locking mechanism, comprising
a rotary latch assembly including:
a main catch rotary latch having a main catch, and
a preliminary catch rotary latch having a preliminary catch,
a catch pawl assembly including,
a preliminary catch pawl, and
a main catch pawl,
wherein the preliminary catch pawl and the main catch pawl are rotatably mounted so as to be coaxial with one another, and
wherein the preliminary catch pawl is configured to interacts with the preliminary catch of the preliminary catch rotary latch in a preliminary catch plane,
wherein the main catch pawl is configured to interact with the main catch of the main catch rotary latch in a main catch plane parallel to and at a distance from the preliminary catch plane, and
wherein the main catch rotary latch and the preliminary catch rotary latch are connected to one another stacked like a sandwich.

2. The locking mechanism according to claim 1,
wherein the main catch rotary latch and the preliminary catch rotary latch each include at least one of an area of a striker receiver and an area of a bearing opening.

3. The locking mechanism according to claim 1, wherein the main catch rotary latch and the preliminary catch rotary latch are metal stamped parts made a same metal.

4. The locking mechanism according to claim 1, wherein the main catch rotary latch and the preliminary catch rotary latch are connected to each other by rivets, screws, or stamping.

5. The locking mechanism according to claim 1, wherein the main catch rotary latch and the preliminary catch rotary latch are connected to each other at least at points.

6. The locking mechanism according to claim 1, wherein the main catch rotary latch and the preliminary catch rotary latch have a coating.

7. The locking mechanism according to claim 1, wherein the main catch rotary latch and the preliminary catch rotary latch consist of materials of different hardness and/or are coated with materials of different hardness.

8. The locking mechanism according to claim 7, wherein the main catch rotary latch is made of a harder material than the preliminary catch rotary latch and/or is coated in a harder material.

9. The locking mechanism according to claim 8, wherein the coating and/or the material of the preliminary catch rotary latch protrudes slightly from the coating and/or the material of the main catch rotary latch such that contact with the catch pawl only occurs on a softer material of the preliminary catch rotary latch.

10. The locking mechanism according to claim 1, wherein the preliminary catch pawl and the main catch pawl are rotatably coupled to each other in such a way that the preliminary catch pawl entrains the main catch pawl after a defined idle travel during an opening process.

11. The locking mechanism according to claim 1, wherein the main catch rotary latch has a latching element pivotably mounted thereon.

12. The locking mechanism according to claim 11, wherein the preliminary catch rotary latch is configured to at least partially secure and cover the latching element.

13. The locking mechanism according to claim 1, wherein the main catch rotary latch and/or the preliminary catch rotary latch are equipped with guides.

14. The locking mechanism according to claim 2, wherein the main catch rotary latch and the preliminary catch rotary latch are each plate-shaped with a predominantly matching surface in an area of the striker receiver and/or the bearing opening.

15. The locking mechanism according to claim 14, wherein the rotary latch further includes a stop arm and a load arm, and wherein the striker receiver is bounded by the stop arm and the load arm.

16. The locking mechanism according to claim 3, wherein the main catch rotary latch and the preliminary catch rotary latch are metal stamped parts made of different metals.
